(19) United States
(12) Patent Application Publication
(10) Pub. No.: US 2013/0090994 A1
(43) Pub. Date: Apr. 11, 2013

(54) XQARD-Dynamic Consumer Focused Real-Time Purchase Discounting Process

(71) Applicant: Rodney C Nash, Novato, CA (US)

(72) Inventor: Rodney C Nash, Novato, CA (US)

(21) Appl. No.: 13/647,553

(22) Filed: Oct. 9, 2012

Related U.S. Application Data
(60) Provisional application No. 61/545,157, filed on Oct. 9, 2011.

(51) Int. Cl. G06Q 30/02

(52) U.S. Cl. 705/14.1

(57) ABSTRACT

The Dynamic Consumer Focused Real-Time Purchase Discounts System is a process/system for generating, authorizing, issuing, transmitting Dynamic Consumer Focused Real-Time Purchase Discounts for individual consumers that provide a plurality of types and quantities of third-party funded real-time purchase discounts. The process gives any individual, group, association, organization, employer, etc. the ability to provide (any amount of prepositioned or secured discount funds, prior to a consumers purchase) sponsored purchase discounts for any specific purchases of a member of a previously specified group, creating a plurality of unique, one-time, dynamic consumer lifestyle focused purchase discounts, occurring only at the time of the consumers purchases, in real-time. Through its very existence, the Dynamic Consumer Focused Real-Time Purchase Discounts System also deploys dynamic consumer focused micro-marketing, dynamic consumer focused nano-marketing, and independently incentivized dynamic consumer focused impulse purchase marketing, integrated within the nexus of third party lifestyle purchase discount funding and the Discount Matrix.

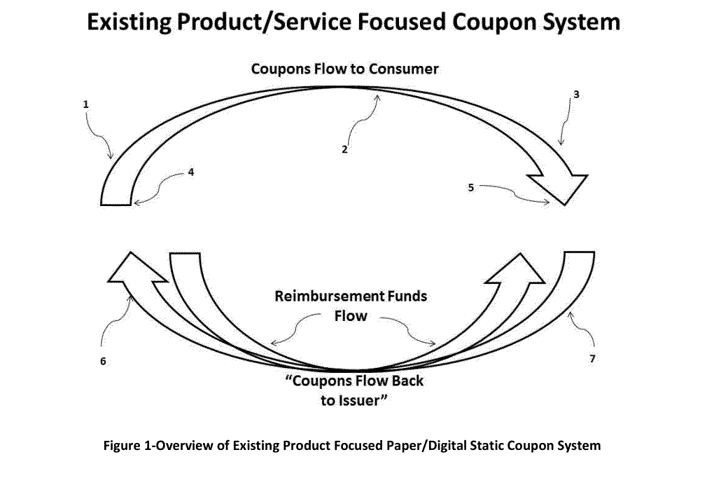

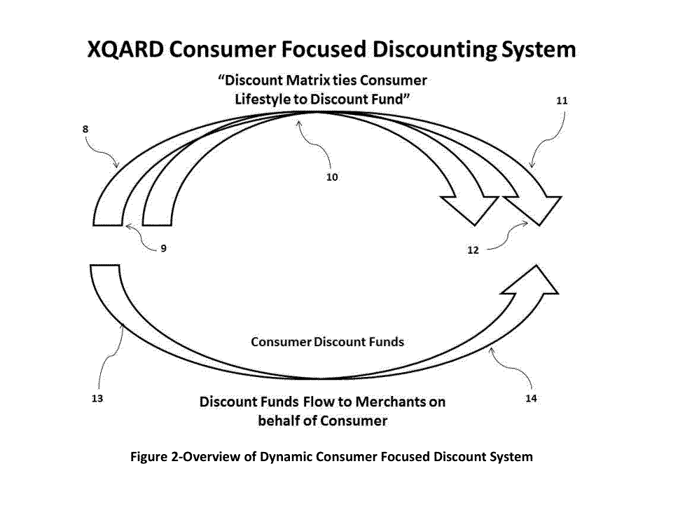

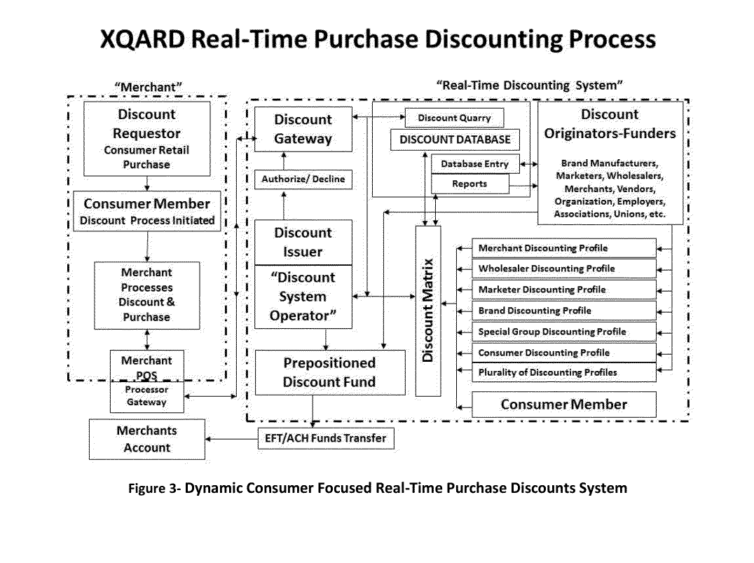

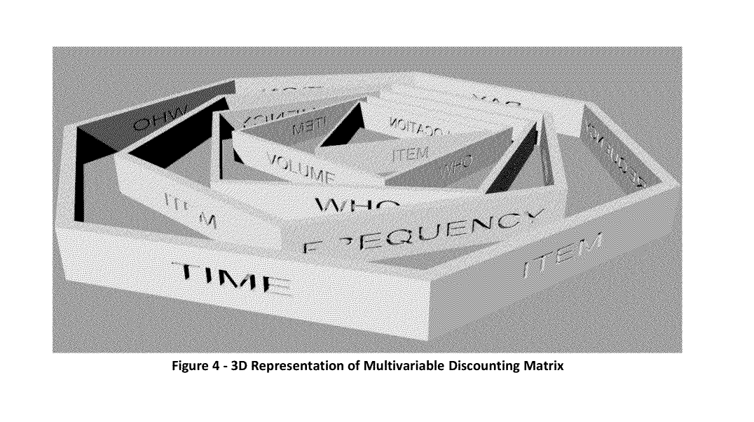

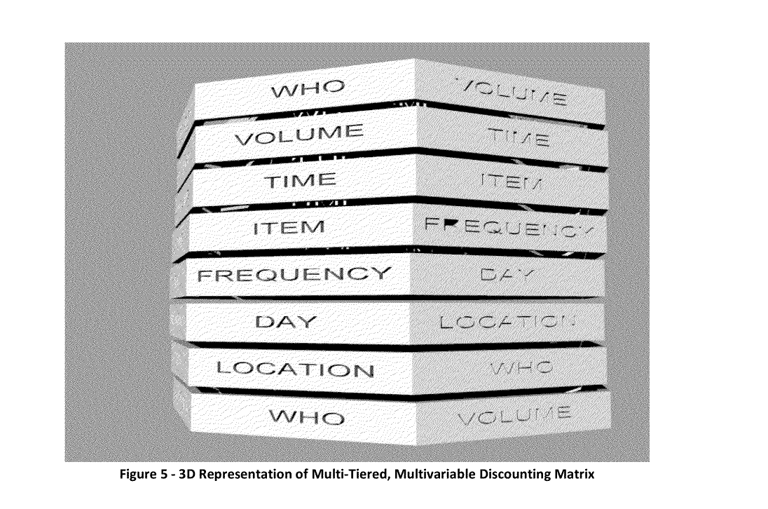

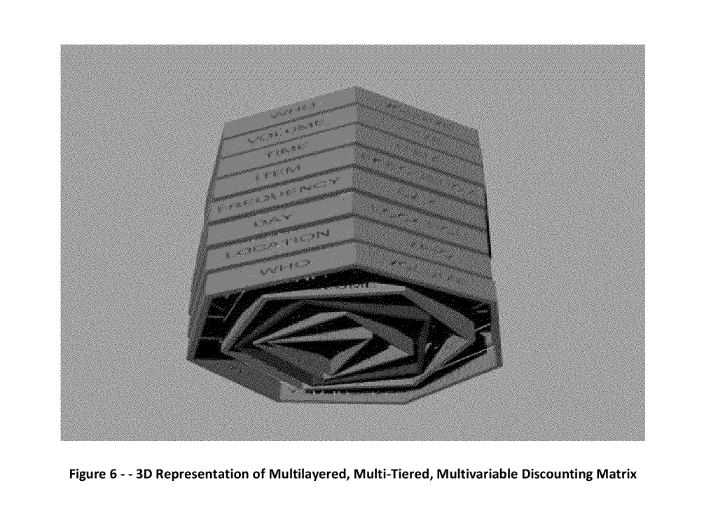

### BACKGROUND OF INVENTION

It is a well-established practice for manufactures, vendors, wholesalers, and retailers to distribute paper coupons as a means of product or services marketing to attract consumers to their particular retail location to purchase advertised products or services. Coupons can be taken to a redemption center, such as a retail store, and redeemed for some type of service, exchanged for currency or other value such as a discount toward a current or future purchase. Coupons do not equal discounts, rather they functions as vouchers and advertisement for a specific purchase discount. Currently coupons are typically sent to a retail clearinghouse after they are redeemed during a purchase, which sorts and counts them & pays or reimburses the retailer. The clearinghouse is then tasked with getting reimbursed by the coupon issuer—either a wholesaler or brand manufacturer; usually the funds are debited from an existing account setup for this specific advertising purpose. This method of marketing or distributing purchase incentives has continued to be somewhat effective since popularization of coupons during the depression and their first use by Coca-Cola in 1894. Though the use of coupons remains high, above 80% of the population, the percentage of coupons actually redeemed, as a percentage of the total coupons issued is astonishingly low. It would appear that most of these users surveyed by the industry associations either don't use coupons regularly with every purchase or there aren't coupons regularly available for the particular items they frequently purchase. While well over 330 Billion coupons are distributed annually only about 4 Billion are redeemed, less than 2%, representing an estimated savings of over $4.7 Billion in recent years. Marketers spent a total of $6.3 Billion on design, production, distribution and redemption of coupons in 2000. According to the government and industry sources, the total value of the all distributed coupons is over $280 Billion. It is not reasonable to expect that all coupons could be redeemed; however a judgment of efficiency of use and therefore cost effectiveness would seem to dictate higher redemption rates. The most highly distributed coupon categories are for household cleaners, condiments, frozen foods, medications, health aids and paper products. There is no public data showing that groups of coupons of the most highly redeemed coupons are the most desired coupons of the purchases of the vendors' desired demographic. Moreover, it would seem that a higher participation rate demonstrated through the higher redemption rate or use of coupons and the acquisition of discounts, not just the amount of individuals using them, is also highly desirable.

It is well known that while a discount is being offered to the purchaser, the primary goal of the brand, wholesaler, marketer or retailer issuing the coupon is incentive based sale and advertisement. While the goal for the consumer is the discount and notification of where the products or services are on sale. Because of the pros and cons associated with the varied manner and methods of coupon distribution, the true statistical acceptance and effectiveness of specific coupons based on demographics is not known. The current mass-marketing process is inefficient and antiquated. Several conditions make the widespread use and acceptance of technology used in everyday life to create new tools, processes, methods, and opportunities that form a more efficient distribution of discounts, not coupons; to deliver specific consumer requested services to more effectively market products by using technology to more efficiently “micro-market” to consumers while decreasing marketing & discount distribution costs. For more than a century, vendors and consumers have perceived coupons and discounts, as equal and that one cannot exist without the other. This well-established practice however, has many disadvantages for the brand, wholesaler, merchant and consumer. For more than a century, consumers and retailers have functioned like two ships passing in the night. One literally casting coupons over the wide ocean like confetti, hoping the coupons find their way to an interested consumers on the other ship. A more accurate analogy is that consumers are adrift at sea (totally isolated, separated and disengaged from the marketing process), waiting for whatever paper coupons comes drifting along.

Here-to-fore coupons have been distributed through a variety of method. These distribution methods have advantages and disadvantages of varying degrees, yet they all have one constant element—the mass market or shotgun distribution pattern. Problems associated with some of these existing distribution processes include: Long lead times for coupon production; some coupons that only reach the consumer (rebate) after the purchase; Little to no demographic targeting or verification; unenforceable provisions of customer limits such as quantity and time; and limited customer reach. Mass-marketing methods, including the internet based methods involve the (transfer of electronic images to paper) application of paper, coupons which lead to a situation where the consumer has to carry, store, and track a plurality of small pieces of paper of varied sizes.

As the use of technology has grown, various technological applications have employed various processes and devices to distribute coupons. Most required additional equipment to be used by the consumer (i.e. such as a computer with internet connectivity and a printer), most are limited in use to individual grocery store chains where items are readily displayed, all require the consumer to be knowledgeable and vigilant with regard to gathering, storing, tracking coupons, ongoing sales, as well as remembering, asking for and attaining a redemption of the coupon at the cashiers station. The traditional methods, previously mentioned are inherently flawed, primarily because of the lack of automation. To the contrary, all of these distribution methods involve, at some level, human involvement in these delivery processes. Discounted transactions represent a very small portion of all retail purchases according to US Dept. of Commerce and trade associations. Added to this weak use of coupons, are several issues or concerns facing the coupon industry such as coupon validation, audit, limited value codes and fraud controls according to recent survey of retailers.

The true goal of the consumer is the attainment of the discount, not to get lost in the process of finding, clipping, collecting, storing, transporting, and redeeming coupons. The true goal of the retailer or vendor, in addition to effective advertising and increased sales is getting more specific information about their customers, to provide better products and services. The true goal of the retailer is to provide buy products that are very likely to be sold and to facilitate the purchase transaction with as much ease as possible without additional costs and inconvenience of providing the discount service to the customer. Most importantly, both parties want to achieve some level of loyalty or trust; trust that the consumer will become a repeat customer and trust that their patronage will be appreciated by the merchant and even rewarded.

The problems associated with using coupons to attain discounts are numerous. They include participating in a pre-purchase activity of some kind i.e., if the coupon is on the packaging of an item previously purchased or rear of the a retail purchase receipt, actions required by the consumer such as cutting or clipping, storing and tracking the paper coupons, and remembering to retrieve them for the next trip to the store if you remember to buy the specific item. Additionally, retail personnel have the added burden of the storage and inventory of a variety of coupons and the retrieval of re-imbursement fee from the vendor; at what is essentially an overhead cost to the retailer. Insofar as the brand vendor or wholesaler of the product is concerned, while they receive direct evidence that consumers are using their coupons, and the number of coupons coming back to the original vendor indicates some small level of success in advertisement execution, there is limited additional marketing information that can be derived from this type of paper coupon distribution and redemption scheme. The original vendors or coupon originator receives no information about the individual consumer which would be of great value in planning future advertising programs, since coupons are submitted anonymously, and contain no information regarding the consumer or his/her purchasing habits or preferences and lifestyle. While some demographic information can be obtained by tracking the regional and geographic locations in which the coupons were redeemed, vendors continue to pay large amount of money on marketing surveys to get statistical data about past or potential customer when real-time purchasing data would be more useful and is attainable with the use of the process that is the subject of this patent.

The current method of paper or electronic coupon generation involves a process developing and budgeting a marketing campaign weeks and sometimes months in advance of their issue and distribution. In general, the current method of paper or electronic coupon origination or issuance involves a process where the manufacturer decides to run a coupon program and sends the coupon to a design agency that handles coupons and paper or electronic coupons, or paper or electronic promotions focused on a product or service. Therefore the redemption as well as, collection or automation of paper or electronic coupons is focused on the product or service, not the consumer. This invention has no such function of designing, distributing or redeeming coupons.

The existing system allows for the issuance of coupons and the redemption of coupons from the manufacturers, marketers, merchants, and wholesalers who heretofore have been the only entities with vested interest in incentivizing the sale of their products. This invention provides a method and system that allows any individual, group, organization, union, employer, etc. to provide a purchase discount for any specific consumer of a previously specified group, union, organization, employer, etc.

The current method of paper or electronic coupon distribution involves a process that randomly distributes free coupons that are regularly used by less than 25% of the buying public. Effectively, vendors are canvassing by over saturating the market of perceived potential shoppers to get discount incentivized sales generation associated with less than 2% of the coupons issued. This is wholly inefficient because of the costs associate with managing, publishing and distribution of these discounts is a large part of most marketers' budgets. This physical handling of coupons is expensive, cumbersome, wrought with errors and subject to manipulation by humans. Additional issues regarding waste and fraud arise from an potential unscrupulous retailer that requests reimbursement payments by presenting unredeemed coupons to the vendors clearinghouse. These are passed on to the coupon originator. The current system is not appreciated or successful as evidenced by the poor level of participation and low percentage sales volume associated with coupons. The overhead associated with design costs, insertion costs, redemption costs, managing and tracking pieces of paper burdens all the participants, from the users, retailers, to the vendors. While only providing the perceived benefit of increased sales for the retailer & vendor and for the consumer, discounts on items purchased because they were on sale not because they were desired. The notion here is that consumers will buy more of something that is truly desired.

In general, the current method of paper or electronic coupons has functions of discount settlement and reimbursement and clearing house remittance of coupons to issuer. This invention provides a method and system for the prepositioning of specific discount funds allocation to a specific consumer member account from a specific group to pay for consumer member focused discounts; also because there are no paper of electronic coupon to reconcile.

In general, the current method of paper or electronic coupons is rife with errors and fraud. This invention provides a method and system for elimination of 100% of errors and fraud associated with paper and electronic coupons or promotions because there are no coupons or promotions.

When carefully analyzed, the many problems and pitfalls associated with existing paper based coupon redemption programs are numerous. A new and innovative solution that utilizes technology is needed to effectively modernize the coupon system and transform it to a more efficient point of sale discounting service that is truly beneficial to all the systems participants, a system and business process that is truly appreciated by all. The proposed system easily conforms to the changing global supply chain and marketing landscape. This invention deploys the concepts of dynamic consumer focused micro-marketing, nano-marketing, and independently incentivized impulse purchasing. The Dynamic Consumer Focused Real-Time Purchase Discounts System overcomes all the deficiencies and disadvantages associated with the current static paper/electronic coupon distribution and redemption system by implementation of a unique and innovative process of generating, authorizing, issuing, transmitting Dynamic Consumer Focused Real-Time Purchase Discounts for individual consumers that provide a plurality of types and amounts of discounts in real-time by providing a process that gives any individual, group, association, organization, union, employer, etc. the ability to provide a prepositioned or secured funds, pre-purchase, sponsored purchase discounts for any specific consumer of a previously specified group purchases and providing a plurality of unique, one-time, individual dynamic consumer specific purchase discounts, occurring only at the time of the consumers purchases, in real-time.

The Dynamic Consumer Focused Real-Time Purchase Discounts System uses existing mechanisms stated in prior art for the purposes described in this invention: such as PVC magnetic strip type ATM/Check Card, smartcards, smartphone, internet software queue or other select identifiers to initiate the discount transaction during the purchase process; existing IT infrastructure to provide a method of connectivity to Discount Database and transaction software via the POS machine or online POS software, POS acquirer/merchant gateway, or other proprietary electronic telecommunication connectivity.

Therefore it is not logically possible to assume that any previous art that includes the use of static paper or electronic coupons, manual or database driven product/service focused discounts could foresee the substance of this invention, or that this invention would be apparent to the skilled artisan in view of the fact that this invention excludes the use of static paper or electronic coupons and manual or database driven product/service focused discounts; the very elements of that prior artwork, i.e. invention of processing paper coupons electronically that would eliminate the use of paper/electronic coupons.

Paper and electronic coupons and product focused discounts are not include, used by or the subject of this invention. This Dynamic Consumer Focused Real-Time Purchase Discounting process consists of elements that prior art related to paper and electronic coupons and discounts processes do not currently possess and functionality they cannot achieve for the following reasons:
The primary purpose of paper coupons and electronic coupons is for mass-marketing or advertisement of item available for consumer purchase; This system does not include a process for mass market product/service focused coupons or discounts.
Prior art related to paper and electronic coupons and discounts provides processes wherein only merchants, manufacturer, marketers, and wholesaler can provide coupons/discounts for their own products or services.
Prior art related to paper and electronic coupons and discounts are based only on a static model of fixed dollar amounts or percentage of an items price.

This Dynamic Consumer Focused Real-Time Purchase Discounts System provides a method of:
1. generating, authorizing, issuing, transmitting a plurality of individual consumer focused discounts in real-time while.
2. allowing any individual, group, organization, union, employer, etc. to provide a purchase discount for any specific consumer of a previously specified group, union, organization, employer, etc.
3. prepositioning of specific discount funds allocation to a specific consumer member of a specific group to prepay for consumer focused discounts vs. reimbursement or clearing house remittance; also because there are not paper of electronic coupon to reconcile.
4. This invention provides a method and system for elimination of 100% of errors and fraud associated with paper and electronic coupons or promotions because there are no coupons or coupon promotions.
5. This invention provides a new method of consumer focused and consumer centric, lifestyle focused micro-marketing and nano-marketing.

The creation of this third-party funding process of retail discounts provides for the elimination of paper or electronic coupons in the Dynamic Consumer Focused Real-Time Purchase Discounts System necessitates the deletion of automated settlement, coupon clearinghouse, and reimbursement processes.

### SUMMARY OF INVENTION

The Dynamic Consumer Focused Real-Time Purchase Discounts System overcomes all the deficiencies and disadvantages associated with the current static paper/electronic coupon distribution and redemption system through the implementation of a new, unique and innovative process of 1) generating, authorizing, issuing, transmitting Dynamic Consumer Focused Real-Time Purchase Discounts for individual consumers that provide a plurality of types and amounts of discounts in real-time. The process gives 2) any individual, group, association, organization, union, employer, etc. the ability to provide (any amount of prepositioned or secured discount funds, prior to a consumers purchase) sponsored purchase discounts for any specific purchases of a consumer member of a previously specified group and providing a 3) plurality of unique, one-time, individual dynamic consumer member specific purchase discounts, occurring only at the time of the consumers purchases, in real-time. The Dynamic Consumer Focused Real-Time Purchase Discounts System eliminates 100% of errors and fraud associated with paper and electronic coupons or promotions because there are no coupons or promotions. All discounts are generated only by the action of Discount Consumer Members. Unlike paper/electronic coupons or paper or electronic promotions, no consumer action other than the purchase of items is required. The discounts are provided based on the consumers discount profile which is set by the discount sponsor, not the manufacturer, marketer, wholesaler or merchant of the product or service. The Dynamic Consumer Focused Real-Time Purchase Discounts System also 4) deploys the concepts of dynamic consumer focused micro-marketing, dynamic consumer focused nano-marketing, and independently incentivized dynamic consumer focused impulse purchasing.

This invention comprises a method and system for generating, authorizing, issuing, transmitting individual consumer focused discounts in real-time by providing any individual, group, association, organization, union, employer, etc. the ability to provide a sponsored purchase discount for any specific consumer of a previously specified group purchases; a discount fund that is sponsored or provided by the consumer members affiliated individual, group, association, organization, union etc.; the prepositioned funds are allocated specifically as discount funds used for the purpose of supporting specific consumer member purchases, to pay for consumer focused purchase discounts; A process of elimination of 100% of errors and fraud associated with paper and electronic coupons or promotions because there are no coupons or promotions.

Unlike paper/electronic coupons or paper or electronic promotions, no consumer action other than the purchase of products or services is required. The discounts are provided on behalf of the consumer group member, based on the consumers discount profile which is set by the consumer's discount sponsor, which is not specifically or directly the manufacturer, marketer, wholesaler or merchant of the product or service being purchased.

The Dynamic Consumer Focused Real-Time Purchase Discounts System functions based on several unique major elements including Discount Fund (DF), Discount Sponsor (DS) or Discount Originator (DO), Discount System Operator (DSO), Discount Issuer (DI), Discount Requestor (DR), Discount Database (DB), Discount Gateway (DG), Discount Consumer Member (DCM), Discount Matrix (DM) manipulating members group profile, individual profile, UPC Data, Purchase Inventory Data (PID), price, purchase location, time of day, day of week, frequency, volume, purchase associations, etc.; Bear in mind that in this Dynamic Consumer Focused Real-Time Purchase Discounts System there is no list or product or service database with exact items listed for discount or specific discount amounts related to specific items or SKU/UPC codes as is the case with existing static coupon/static discount system.

The Dynamic Consumer Focused Real-Time Purchase Discounts System uses a combination of existing and new mechanisms, infrastructure and proprietary software code for the purposes (described in the detail description) such as PVC magnetic strip type ATM/Check Card, smartcards, smartphone, Internet software cue or other select identifiers to initiate the discount transaction during the purchase process; existing IT infrastructure to provide a method of connectivity to Discount Database, Discount Matrix and transaction software via the POS machine or online POS software, POS acquirer/merchant gateway, Discount Transaction Gateway or other proprietary electronic telecommunication connectivity.

The Dynamic Consumer Focused Real-Time Purchase Discounts System deploys the concepts of dynamic consumer focused micro-marketing, nano-marketing, and independently incentivized impulse purchasing by providing a means of:
generating, authorizing, issuing, transmitting a plurality of individual consumer focused discounts in real-time while.
allowing any individual, group, organization, union, employer, etc. to provide a purchase discount for any specific consumer of a previously specified group, union, organization, employer, etc.
prepositioning of specific discount funds allocation to a specific consumer member of a specific group to prepay for consumer focused discounts vs. reimbursement or clearing house remittance; also because there are not paper of electronic coupon to reconcile.
This invention provides a method and system for elimination of 100% of errors and fraud associated with paper and electronic coupons or promotions because there are no coupons or promotions.
This invention provides a method of consumer focused and consumer dependent micro marketing and nano-marketing and, and independently incentivized impulse purchasing.

### BRIEF DESCRIPTION OF DRAWINGS

1. Existing Paper/Electronic Coupon Discount Process Flows

This diagram demonstrate the major elements and process flow of existing Static Product and Service focused paper and electronic System. 1—“Coupon Generators” Develop Marketing & Reimbursement Budgets for Products/Services. 2—“Coupon Distributors” Print & Digital mass media outlets, Coupon Clubs, etc. 3—Coupon Users” Redeem coupon for goods/services at merchant location. 4—“Coupon Issuers” Items Selection by Manufacturers, Merchants, Marketers & Wholesalers. 5—“Merchants” Collect Reimbursement from coupon bundlers. 6—“Coupon Clearing House” Accept Clear and reimburse Coupons Bundlers. 7—“Coupon Bundlers” Batch, Sort & Bundle Coupons, Reimburse Merchants

2. Dynamic Consumer Focused Real-Time Purchase Discounts System Process Flows

This diagram demonstrate the major elements and process flow of existing Dynamic Consumer Focused Real-Time Purchase Discount System. 8—“Discount Generator” Consumer's Profile selections or Group's Profile of Products/Services. 9—“Discount Originator” Discount Sponsor—provide financial sponsorship of Consumer's Discount Fund. 10—“Discount System Operator” Prepositions Discount Funds in Secured Accounts for payment of discounts. 11—“Discount Users” Makes Purchases—Discounts follow Consumer at Merchant. 12—“Merchants” Receives Direct Payment from Discount System Operator. 13—Discount Funds Prepositions Discount Funds provided by Sponsor, Controlled by Discount System Operator tied to Consumer Account. Consumer Discount Funds Flow from Originator via Discount System Operator to Merchant only at time of purchase. 14—“Discount Funds” matched and allocated to Consumer Discounted item in Real-Time at time of purchase

3. Dynamic Consumer Focused Real-Time Purchase Discounts System Diagram.

This diagram demonstrate the major elements involved in the real-time discounting process and business method of distributing discounts according to the method prescribed in this patent. The interrelations, hierarchy and communication process of these entities for the purpose of distributing discounts is the essence of this patent.

4. 3D—Visual Representation of Multi-Variable Discount Matrix Diagram

This diagram demonstrate the major entities involved in the process of distributing a Multi-Variable consumer focused discount according to the method prescribed in this patent. The 3 dimensional interrelations, hierarchy and communication process of these entities for the purpose of distributing discounts is the essence of this patent.

5. 3D—Visual Representation of Multi-Tiered, Multi-Variable Discount Matrix Diagram

This diagram demonstrate the major entities involved in the process of distributing Multi-Tiered, Multi-Variable discount according to the method prescribed in this patent. The interrelations, hierarchy and communication process of these entities for the purpose of distributing discounts is the essence of this patent.

6. 3D—Visual Representation of Multi-Layered, Multi-Tiered, Multi Variable Discount Matrix Diagram

This diagram demonstrate the major entities involved in the process of distributing Multi-Layered, Multi-Tiered, Multi Variable discount according to the method prescribed in this patent. The interrelations, hierarchy and communication process of these entities for the purpose of distributing discounts is the essence of this patent.

### DETAILED DESCRIPTION

The Dynamic Consumer Focused Real-Time Purchase Discounts System functions based on several unique major elements including Discount Fund, Discount Sponsor, Discount System Operator, Discount Issuer, Discount Requestor, Discount Gateway, Discount Consumer, Discount Matrix (DM) manipulating members group profile, individual profile, UPC Data, Purchase Inventory Data (PID), price, purchase location, time of day, day of week, frequency, volume, purchase associations, etc.; Bear in mind that in this Dynamic Consumer Focused Real-Time Purchase Discounts System there is no list or product or service database with exact items listed for discount or specific discount amounts related to specific items or SKU/UPC codes as is the case with existing static coupon/static discount system.

Therefore it is not logically possible to assume that any previous art that includes the use of static paper or electronic coupons, manual or database driven product/service focused discounts could foresee the substance of this invention, or that this invention would be apparent to the skilled artisan in view of the fact that this invention excludes the use of static paper or electronic coupons and manual or database driven product/service focused discounts; the very elements of that prior artwork. i.e. invention of processing paper coupons electronically that would eliminate the use of paper/electronic coupons.

Paper and electronic coupons and product focused discounts are not include, used by or the subject of this invention. This Dynamic Consumer Focused Real-Time Purchase Discounting process consists of elements that prior art related to paper and electronic coupons and discounts processes do not currently possess and functionality they cannot achieve for the following reasons:
The primary purpose of paper coupons and electronic coupons is for mass-marketing or advertisement of item available for consumer purchase; This system does not include a process for mass market product/service focused coupons or discounts.
Prior art related to paper and electronic coupons and discounts provides processes wherein only merchants, manufacturer, marketers, and wholesaler can provide coupons/discounts for their own products or services.
Prior art related to paper and electronic coupons and discounts are based only on a static model of fixed dollar amounts or percentage of an items price.

This Dynamic Consumer Focused Real-Time Purchase Discounts System provides a method and system for generating, authorizing, issuing, transmitting a plurality of individual consumer focused discounts in real-time while. This invention provides a method and system that allows any individual, group, organization, union, employer, etc. to provide a purchase discount for any specific consumer of a previously specified group, union, organization, employer, etc. This invention provides a method and system for the prepositioning of specific discount funds allocation to a specific consumer member of a specific group to prepay for consumer focused discounts vs. reimbursement or clearing house remittance; also because there are not paper of electronic coupon to reconcile. This invention provides a method and system for elimination of 100% of errors and fraud associated with paper and electronic coupons or promotions because there are no coupons or promotions.

Elimination of paper or electronic coupons in the Dynamic Consumer Focused Real-Time Purchase Discounts System necessitates the deletion of automated settlement, clearinghouse, and reimbursement processes. The existing method calls for the marketer, printer or originator of the coupon to provide settlement, and reimbursement which is not possible in real time. Electronic coupons need to be printed and presented at point of sell, a factor that is not disclosed in the previous art as printing a common item for display is not a patentable process.

Under this Dynamic Consumer Focused Real-Time Purchase Discounts System there is minimal threat of high level of abuse and fraud that currently exists with traditional paper coupons because discounts are applied directly to purchases and completed at the point of sale, in real time; or with another merchant for the purchase of branded or non-branded product or service similar to that of the previous documented purchase. There is no additional work for the merchant representative or store clerk to perform at the end of their shift, as there are no coupons to redeem.

The Dynamic Consumer Focused Real-Time Purchase Discounts System comprises processes relating to the following 8 or 10 (depending on boundary definitions) major elements, accomplishing the following tasks:
1. Discount Fund (DF)—Prepositioned funds, provided by DS, specifically allocated to

Discount Consumer Member (DCM) for the purposes of paying for non-product/service specific consumer focused discounts.
2. Discount Sponsor (DS) or Discount Originator (DO)—Any individual, group, organization, union, association, employer, etc. that provides sponsorship or contribution to its consumer member's discount fund. Also known as the Discount Originator, the entity that provides the purchase discount funds.
3. Discount System Operator (DSO)—Provides overall system command and control.

Manages and processes discount profile, transaction data flow, and processes real-time purchase discount transactions received across the Discount Gateway; Accesses and controls Discount Matrix, manages Discount Database.
4. Discount Issuer (DI)—The merchants or retailers who performs the act of honoring initiation devices and provides initial electronic connection and transmission by accepting the Discount Consumer Members ID to initiate discount transaction, accept payment process authorizations and final payment.
5. Discount Database (DB)—Discount Database and electronic communications infrastructure which stores and allows query and reporting of a plurality of data from numerous retailers, manufacturers and vendors of specific services, products and product information by consumer purchase inventory data discount requests electronically connected via existing public or proprietary electronic data links. The purchase discounting process allows consumers at point of purchase to receive instant in-store discounting of item/s or services currently being purchased.
6. Discount Gateway (DG)—front end transaction switch and transaction management software and management server system front end.
7. Discount Consumer Member (DCM), Discount Requestor (DR)—The consumers,

Discount Requestors can access the system at a plurality of purchase locations or system interface points i.e. pos machine and software, online software, mobile, etc., that honor any plurality of discount system ID devices. Utilized discount fund to offset the costs of a plurality of direct purchases, based on consumer focused profile and group membership affiliation.
8. Discount Matrix (DM)—Software manifestation of Discount Consumer Merchant profile integration, and transaction processing. The Matrix operates in a plurality of Dynamic Consumer Focused Real-Time Purchase Discount configurations i.e. Multi-Variable; Multi-Layered, Multi-Variable; Multi-Layered, Multi-Tiered, Multi-Variable, etc.; based on DCM profiles synchronization with Discount Database, Discount Sponsor, Discount Fund, and the Discount System Operator.

The Dynamic Consumer Focused Real-Time Purchase Discounts system uses existing mechanisms stated in prior art for the purposes described in this invention: such as PVC magnetic strip type ATM/Check Card, smartcards, smartphone, internet software queue or other select identifiers to initiate the discount transaction during the purchase process; existing IT infrastructure to provide a method of connectivity to Discount Database and transaction software via the POS machine or online POS software, POS acquirer/merchant gateway, or other proprietary electronic telecommunication connectivity.

Additionally, this real-time discount process patent covers a method of command and control of storage, quarry, system authorization, reporting from the Discount Database, and consumer and vendor system inputs for use within the Discount Matrix. The telecommunication link or functionary that provides user system interface is known as the backend. The process provides a method of establishing and operating functionaries that provide real-time Discount ACH Authorizations. The process can offer a plurality of discounts to different users of the system. Funds are available before they make product or service purchase selections on the basis of group affiliation profile, previously, voluntarily disclosed consumer profile data to the Discount Database and Discount Matrix. The real-time discounting process comprises a plurality of Discount Funds, which are an optional feature that exist when Discount Originators, DS who sponsor specific groups of consumers pre-position funds into accounts, (accounts are not the subject of this patent) that will be used for reimbursement of the merchant's discounted transactions. Once the automated and secure verification of the inventory of purchased items is achieved from the merchant and the DSO authorizes the exact amount of discount to be credited to the merchant, that the merchant extends the full discount to the customer and continues or completes the purchase transaction. The step of funds replenishment by the DO provides the funding required to maintain minimum account funding levels that were previously predetermined by the DO and consumer group member as appropriate for each member of the sponsored consumer group in order to support future discounted purchases.

Once given the above disclosure, many features, modification, and improvements will become apparent to the skilled artisan. Such other features, modifications, and improvements are therefore considered to be a part of this invention, the scope of which is to be determined by the following claims.

What I claim as my invention is:

1. A method of generating Dynamic Consumer Focused Real-Time Purchase Discounts for individual consumers based on previously secured, third-party funding or sponsorship of individual consumer's lifestyle, affinity, organization, group, etc., that provides a plurality of types and amounts of unique purchase discounts in real-time.

2. A method of transmitting Dynamic Consumer Focused Real-Time Purchase Discounts for individual consumers electronically, from location of purchase to purchaser data file, quarry, report, and approval result back to location of purchase, in real-time that provides a plurality of types and amounts of discounts for each individual consumer, regardless of item purchased, because the ultimate unique purchase discount is a function of the Discount Matrix.

3. A method of providing any individual, group, association, organization, union, employer, etc. the ability to provide (any amount of prepositioned or secured discount funds, prior to a consumers purchase) sponsored unique purchase discounts for any specific purchases of a consumer member of a previously specified group

4. The method of providing plurality of unique, one-time, individual dynamic consumer specific purchase discounts through the Discount Matrix, that are created and exist only at the moment of the individual consumer's purchases, occurring in real-time comprising:
a. Multi-Variable Discount Matrix process that produces a real time request for distributing a unique Multi-Variable consumer focused purchase discount according to the method prescribed in claims 1-3.
b. Multi-Tiered, Multi-Variable Discount Matrix process that produces a real time request for distributing a unique Multi-Tiered, Multi-Variable consumer focused purchase discount according to the method prescribed in claims 1-3.
c. Multi-Layered, Multi-Tiered, Multi Variable Discount Matrix process that produces a real time request for distributing a unique Multi-Layered, Multi-Tiered, Multi Variable consumer focused discount according to the method prescribed in claims 1-3.

5. A method of deploying the concepts of dynamic consumer focused micro-marketing, dynamic consumer focused nano-marketing, and independently incentivized dynamic consumer focused impulse purchasing integrated within the nexus of third party lifestyle purchase discount funding and Discount Matrix according to the methods prescribed in claims 1-4.
